(19) United States
(12) Patent Application Publication
(10) Pub. No.: US 2007/0143531 A1
(43) Pub. Date: Jun. 21, 2007

(54) Power loss recovery for bit alterable memory

(76) Inventor: Sunil R. Atri, Folsom, CA (US)

Correspondence Address: INTEL CORPORATION;c/o INTELLEVATE, LLC, P.O. BOX 52050, MINNEAPOLIS, MN, 55402, US

(21) Appl. No.: 11/303,238

(22) Filed: Dec. 15, 2005

(51) Int. Cl. G06F 12/00

(52) U.S. Cl. 711/103

(57) ABSTRACT

A bit alterable memory device may include status bits such as a direction bit and two register bits for a colony of memory cells. The state of each status bit may be changed depending on the programming state of the non-volatile bit alterable memory. The status bits may be examined to determine the write status of two separate colonies of memory cells in the event of a power loss. The information gathered from the status bits can be used by a power loss recovery mechanism to determine whether the data written to a plurality of memory cell colonies is partially written. Applying a power loss recovery mechanism to a bit alterable memory can prevent the user from relying on data that is corrupt or otherwise unusable.

### TECHNICAL FIELD

The present disclosure relates generally to memory devices, and more particularly, to methods and apparatus for tracking the status of data or code written to non-volatile bit alterable memory.

### BACKGROUND

The present disclosure relates to non-volatile semiconductor memories and particularly to bit-alterable memories. Non-volatile memory refers to a type of solid state memory that retains stored information without the need for a constant power source. Non-volatile bit alterable memory is a non-volatile memory that can be programmed and erased on a bit level. This means that each individual memory cell carrying distinct pieces of data or charge can be changed independently of other pieces of data.

Non-volatile memory that is erased and programmed using an electrical field or charge is known as Electronically Erasable Programmable Read Only Memory (EEPROM). Standard EEPROM is erased by changing one byte, or string of bits, of memory at a time. A commonly used version of EEPROM, known as flash memory, is erased and sometimes programmed by changing a whole block of bytes at one time, typically on the order of 64,000 bytes. Flash memory is operationally efficient because the erase process occurs on a block level instead of a bit or byte level. One drawback is that if only a very small amount of memory needs to be updated, it is also necessary to erase a whole block of memory to accommodate the change.

Though non-volatile memory are designed to retain data without the need for a continuous power source, the program and erase operations does require a continuous power source. An unexpected loss of power during the writing or erasing cycle of the flash device may lead to corrupt or invalid data in the memory, resulting in undesirable consequences for the end user. Methods have been applied to detect instances of power loss during the writing or erasing of non-volatile memory. Such methods have included the use of status bits to track the status of the write or erase process and the resulting state of the memory. As an example, an erased block could begin with no status bits written, indicating that the block has been successfully erased. Similarly, one status bit could be written to indicate that a write process has commenced. A second status bit could be written to indicate that a write process has completed, signaling a valid write operation.

FIG. 1 is a flowchart describing the state of the art for power loss recovery (PLR) of a write process in a flash memory block. The process begins with no status bits written, indicating that the memory is erased and ready for programming. The write or programming process, tracked with a power loss recovery mechanism, begins by writing a start status bit 102. The presence of a start status bit in a memory cell indicates that a programming process has commenced in the flash memory block. The memory cells within the flash memory block are then programmed with data or code 104. The flash memory block is in a programming state until all the necessary information has been written 106. A second status bit is written, indicating that the programming process has stopped 108 once the programming process is complete. The status of the flash memory block can subsequently be checked to determine whether the programming process was successful for the particular flash memory block. If no status bits are written, the flash memory block is erased and ready for programming. If one status bit is written, the flash memory block is partially programmed. If two status bits are written, then the flash memory block has been successfully written.

FIG. 2 illustrates the method described in FIG. 1. The flash memory device can begin as a plurality of invalid or erased flash memory blocks 200. The programming status of one flash memory block 205 is tracked by start status bit 210 and stop status bit 220. When a flash memory block has been selected for programming, the start status bit 210 is written 230 to indicate the commencement of programming of the corresponding flash memory block. The start status bit continues to indicate the writing of data or code until the corresponding flash memory block has been updated with information 240. The stop status bit 220 is written once the writing of information to the flash memory block has completed 250, resulting in a valid flash memory block. The flash memory device can include power loss recovery hardware or software to detect invalid or unreliable data. In one embodiment, the flash memory device may include a microcontroller to execute code (e.g. microcode or firmware) to perform power loss recovery functions.

Using two status bits per block to track the state of a collection of flash memory blocks can become burdensome when the amount of data tracked per block decreases, due to the corresponding increase in status bits. Thus, there is a need to reduce the number of status bits required to track programming states as the size of the flash memory blocks decrease.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 (PRIOR ART) is a flowchart of a prior art method for writing power loss recovery status bits to a flash memory device;

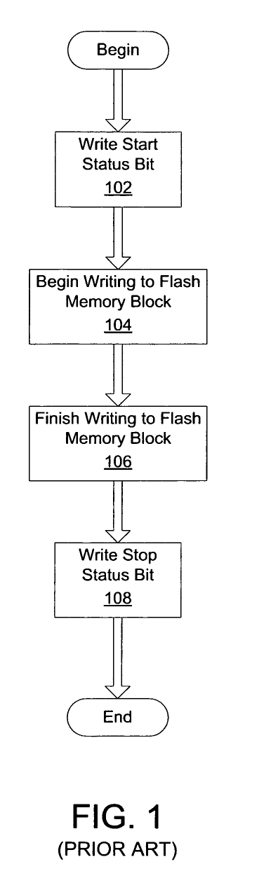

FIG. 2 (PRIOR ART) illustrates a prior art method for tracking the state of a flash memory block in a flash memory device;

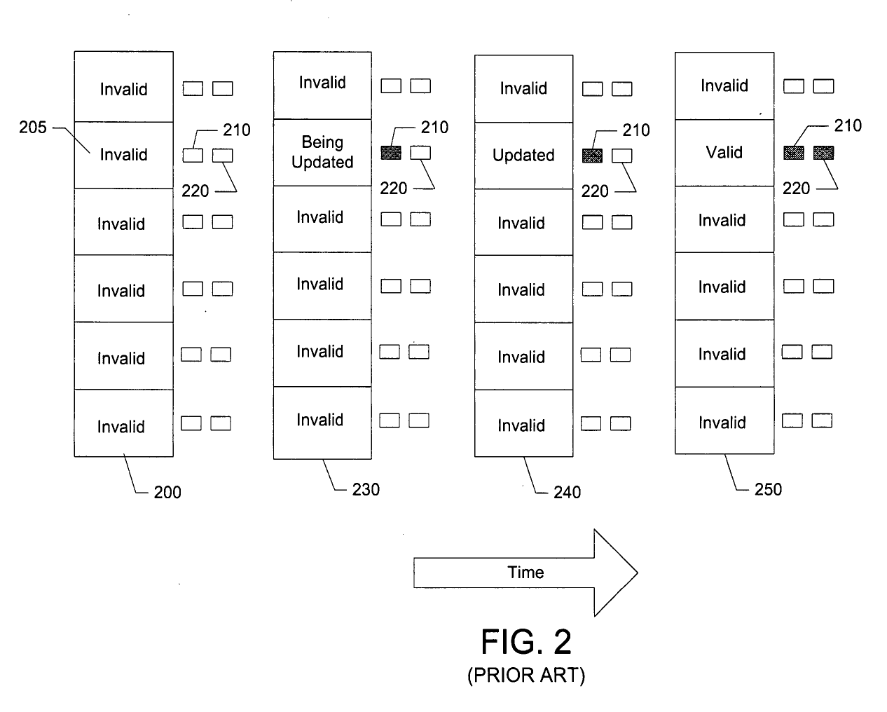

FIG. 3 is a flowchart for reading and transferring the contents of a memory colony from a non-volatile bit alterable memory;

FIG. 4 is a flowchart for reading the direction and grey code bits in a non-volatile bit alterable memory to determine the programming states of two memory colonies;

FIG. 5 illustrates a method for tracking the programming state of several non-volatile bit-alterable memory colonies;

FIG. 6 is a block diagram of a wired or wireless system including a non-volatile bit-alterable memory.

FIG. 7 illustrates a non-volatile bit alterable memory with a power loss recovery interface.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

### DETAILED DESCRIPTION

the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the description.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other while “coupled” may further mean that two or more elements are not in direct contact with each other, but yet still co-operate or interact with each other.

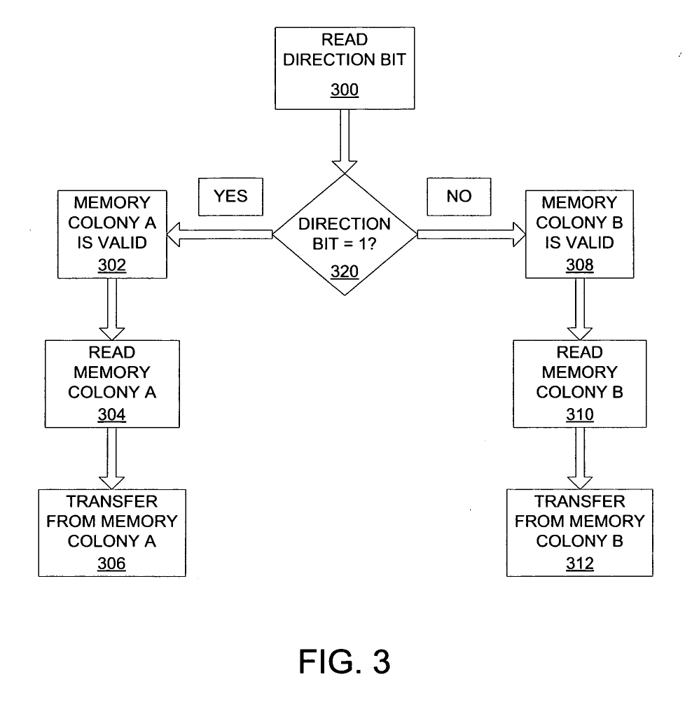

FIG. 3 is a flowchart describing an embodiment of power loss recovery of a write process in a bit alterable non-volatile memory. One such type of memory technology is known as Ovonic Unified Memory (OUM). Ovonic Unified Memory is a high density memory device characterized by small and tightly packed memory cells. Each individual memory cell includes a small volume of phase-change chalcogenide alloy. In one embodiment, the phase of the alloy can be a high resistivity amorphous phase or a low resistivity crystalline phase, resulting in digital data bits of either a one (“1”) or a zero (“0”). Alternatively, the phase of the alloy can be a plurality of intermediate phases, allowing for multiple bits per memory cell.

In this embodiment, two memory colonies may be used interchangeably to store valid data. A memory colony is a collection of one or more memory cells, wherein each memory cell contains one or more bits of data. The two memory colonies are redundant memory locations, allowing one memory location to store existing data or code while the second memory location is updated with new information. In this embodiment, two memory colonies A and B are tracked so their programming status can be determined using a power loss recovery mechanism. An interface may comprise a write state machine to determine the status of a programming process. A write state machine applies power loss recovery code to read a direction bit for two memory colonies 300 to determine which memory colony contains valid data. The direction bit may be located in a neighboring memory cell and may be used to indicate whether the information in a first memory colony or a second memory colony is valid. In one embodiment, if the direction bit is equal to one at block 320, also referred to as a first state, then the memory colony A is determined valid 302. The value of the direction bit may be inverted to a zero or used differently in alternative embodiments. The valid data from the memory colony A can then be read 304 and later transferred or copied from the memory colony A to a different location 306 either inside the non-volatile bit alterable memory or outside the non-volatile bit alterable memory.

Referring back to block 320, if the direction bit is not equal to one (e.g., the direction bit is zero), then the direction bit is at a second state and the memory colony B is determined valid 308. The valid data from the memory colony B is then read 310 and later transferred or copied from the memory colony B to another location 312 using a memory file management system.

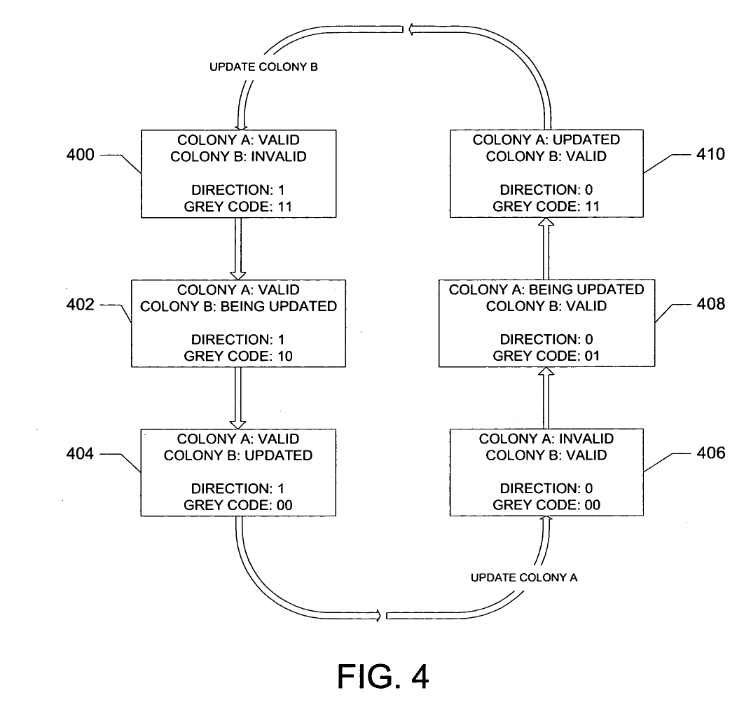

FIG. 4 is a diagram of one embodiment of a power loss recovery mechanism. The power loss recovery mechanism in one embodiment may be an integral part of a non-volatile memory device, such as an Intel Strataflash® Wireless Memory. If the power loss recovery mechanism reads a direction bit and determines the direction bit is at a first state, then the memory colony A is valid 400. By reading the corresponding grey code bits and determining that both grey code bits are each at a first state, the power loss recovery mechanism determines that the memory colony B is invalid and is available for programming. Grey code is a term used in the industry which indicates that with each successive change in code, a new code differs from a previous code by one bit.

Upon programming the memory colony B, the direction bit and a first register grey code bit remain at a first state “1” and a second register grey code bit is changed to a second state “0”. This indicates that the memory colony A is valid and the memory colony B is being updated 402. When the write process to the memory colony B is complete, the first register bit is changed to a second state “0” and the two remaining status bits remain unchanged. This indicates that the memory colony A is valid and the memory colony B is updated 404.

To make the updated data available for use, the memory colony B is marked as valid and the memory colony A is marked invalid, thereby making the memory colony A available for an update. This condition is set by leaving the grey code status bits in a second state “0” and changing the direction bit to a second state “0” 406. The memory colony A is updated similarly to the memory colony B by first changing the second register status bit from a second state “0” to a first state “1” and leaving the remaining status bits unchanged. This indicates that the memory colony B is valid and the memory colony A is being updated 408. When the data has been completely written to the memory colony A, the first register bit is changed from a second state “0” to a first state “1.” This indicates that the memory colony A is updated and that the memory colony B is valid 410. This method allows two separate memory colonies to share three status bits to indicate the memory state of each memory colony.

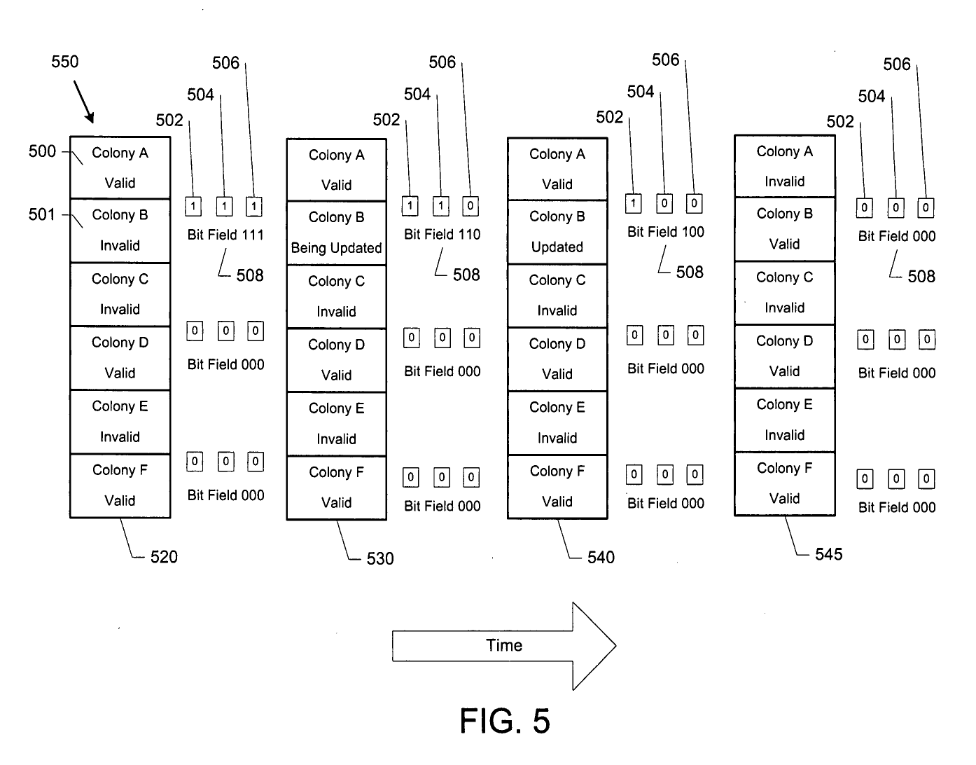

FIG. 5 illustrates one embodiment of FIG. 4 may the status of a memory colony A 500 and memory colony B 501 in a non-volatile bit alterable memory 550. In one embodiment at time t0 520, the memory colony A 500 and the memory colony B 501 share three status bits: a direction bit 502, a first register bit 504 and a second register bit 506. A corresponding bit field 508 may include the direction status bit 502, the first register bit 504, and the second register bit 506. When the memory colony A 500 is filled with valid data and the memory colony B 501 is filled with invalid data, the direction bit 502, the first register bit 504, and the second register bit 506 are all at a first state “1”. he corresponding bit field 508, may be “111”.

In another example at time t1 530, the memory colony B 501 may be in the process of being updated. In particular, the second register bit 506 is changed from a first state “1” to a second state “0”. Thus at time t1, the corresponding bit field 508 may be “110”.

In a later example at time t2 540, the memory colony B 501 may be updated. In particular, the first register bit 504 is changed from a first state “1” to a second state “0”. Thus at time t2, the corresponding bit field 508 may be “100”.

In a further example at time t3 545, the memory colony B 501 may be determined valid. In particular, the direction bit 502 is changed from a first state “1” to a second state “0”. Thus at time t3, the corresponding bit field 508 may be “000”. The power loss recovery mechanism determines the state of two memory colonies by reading the bit field and can therefore assist the memory device in avoiding the use of corrupt or partially written data.

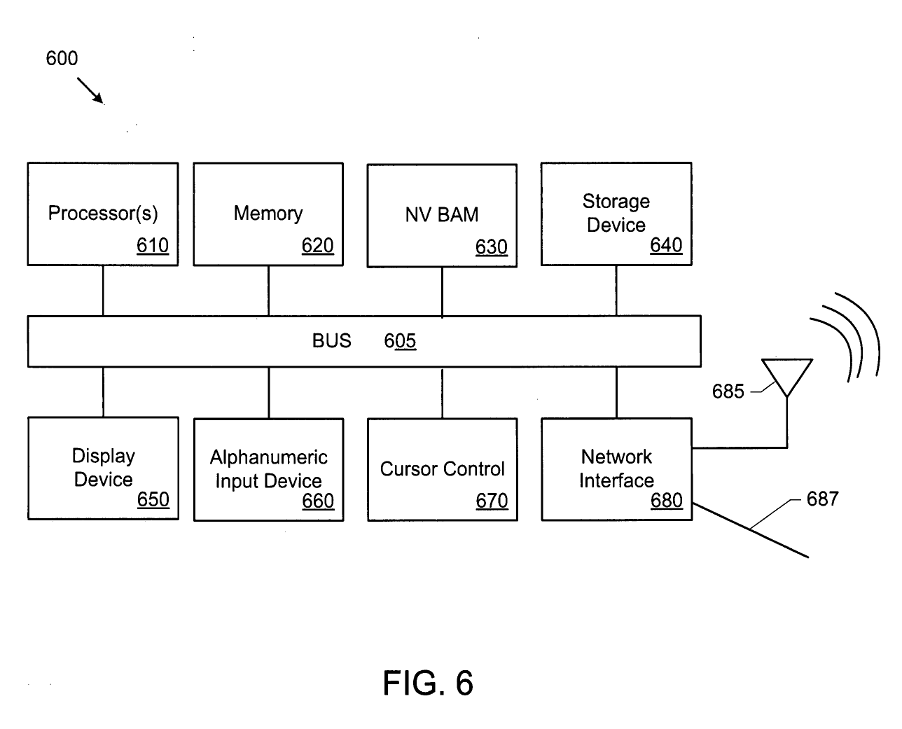

FIG. 6 is a block diagram of one embodiment of an electronic system. The electronic system illustrated in FIG. 6 is intended to represent a range of electronic systems (either wired or wireless) including, for example, desktop computer systems, laptop computer systems, cellular telephones, personal digital assistants (PDAs) including cellular-enabled PDAs, set top boxes. Alternative electronic systems may include more, fewer and/or different components.

The electronic system 600 includes a bus 605 or other communication device to communicate information, and a processor 610 coupled to the bus 605 that may process information. While the electronic system 600 is illustrated with a single processor, the electronic system 600 may include multiple processors and/or co-processors. The electronic system 600 further may include random access memory (RAM) or a dynamic storage device 620 (referred to as main memory), coupled to the bus 605 and may store information and instructions that may be executed by the processor 610. The main memory 620 may also be used to store temporary variables or other intermediate information during execution of instructions by the processor 610.

The electronic system 600 may also include a non-volatile bit alterable non-volatile memory (NV BAM) storage device 630 coupled to bus 605 that may store code or data for the processor 610. A data storage device 640 may be coupled to the bus 605 to store information and instructions. The data storage device 640 such as a magnetic disk or optical disc and corresponding drive may be coupled to the electronic system 600.

The electronic system 600 may also be coupled via the bus 605 to a display device 650, such as a cathode ray tube (CRT) or liquid crystal display (LCD), to display information to a user. An alphanumeric input device 660, including alphanumeric and other keys, may be coupled to the bus 605 to communicate information and command selections to the processor 610. Another type of user input device is a cursor control 670, such as a mouse, a trackball, or cursor direction keys to communicate direction information and command selections to the processor 610 and to control cursor movement on the display 650.

The electronic system 600 further may include a network interface(s) 680 to provide access to a network, such as a local area network. The network interface(s) 680 may include, for example, a wireless network interface having an antenna 685, which may represent one or more antenna(e). The network interface(s) 680 may also include, for example, a wired network interface to communicate with remote devices via a network cable 687, which may be, for example, an Ethernet cable, a coaxial cable, a fiber optic cable, a serial cable, or a parallel cable.

In one embodiment, the network interface(s) 680 may provide access to a local area network, for example, by conforming to Electrical Institute of Electrical and Electronic Engineers (IEEE) 802.11b and/or IEEE 802.11g standards, and/or the wireless network interface may provide access to a short-range personal area network, for example, by conforming to Bluetooth standards. Other wireless network interfaces and/or protocols can also be supported.

IEEE 802.11b corresponds to IEEE Standard 802.11b-1999 entitled “Local and Metropolitan Area Networks, Part 11: Wireless Local Area Network (LAN) Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Standard 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents. Bluetooth protocols are described in “Specification of the Bluetooth System: Core, Version 1.1,” published Feb. 22, 2001 by the Bluetooth Special Interest Group, Inc. Associated as well as previous or subsequent versions of the Bluetooth standard may also be supported.

In addition to, or instead of, communication via wireless LAN standards, the network interface(s) 680 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol.

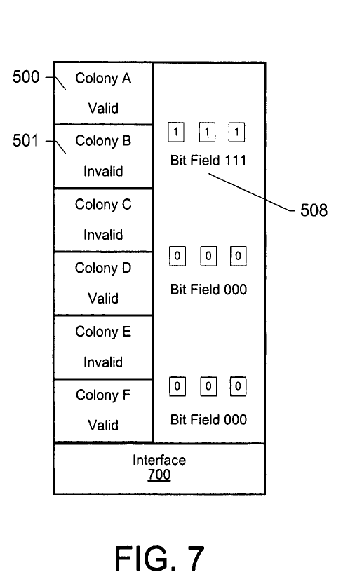

FIG. 7 is one embodiment of a bit alterable memory with a power loss recovery interface. The non-volatile bit alterable memory illustrated in FIG. 7 is intended to represent an example of a plurality of cell colonies connected to an interface 700 used for power loss recovery. Alternatively, the non-volatile bit alterable memory may include the interface 700 coupled to a plurality of cell colonies. The interface 700 may comprise a write state machine to determine the status of a programming process. As one example, the write state machine may apply power loss recovery code to read the bit field 508 to determine whether the memory colony A 500 or the memory colony B 501 contains valid data.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. A method comprising:
providing a direction bit and at least two register bits for a plurality of cell colonies in a bit alterable memory; and
determining a programming state of the plurality of cell colonies based on the direction bit and the register bits.

2. The method of claim 1 wherein at least one of the register bits contains a grey code.

3. The method of claim 1 wherein the method is used for power loss recovery.

4. The method of claim 1, further comprising configuring a number of cells in each of the plurality of cell colonies.

5. The method of claim 1 further comprising determining whether the direction bit is at a first state or a second state in response to reading the direction bit.

6. The method of claim 5 wherein if the direction bit is at the first state, designating that a first memory cell colony is valid.

7. The method of claim 5 wherein if the direction bit is at the first state and each of the register bits is at the first state, designating that a first memory cell colony is valid and at least one of the plurality of cell colonies is invalid.

8. The method of claim 5 wherein if the direction bit and one register bit is at the first state and at least one register bit is at the second state, designating that the programming operation is not complete.

9. The method of claim 5 wherein if all register bits are at the second state, designating that at least one of the plurality of cell colonies is updated.

10. The method of claim 5, wherein if the direction bit is at the second state, designating that a second memory cell colony is valid.

11. The method of claim 5, wherein if the direction bit is at the second state and each of the register bits is at second state, designating that second memory cell colony is valid and at least one of the plurality of cell colonies is invalid.

12. The method of claim 5, wherein if the direction bit and one register bit is at the second state and at least one register bit is at the first state, designating that the programming operation is not complete.

13. The method of claim 5, wherein if the register bits are not at the second state, designating that at least one of the plurality of cell colonies is updated.

14. An article comprising a medium storing instructions that enable a system to:
provide a direction bit and at least two register bits for a plurality of cell colonies in a bit-alterable memory; and
determining a programming state of the plurality of cell colonies based on the direction bit and the register bits.

15. The article of claim 14, wherein at least one of the register bits contains a grey code.

16. The article of claim 14, wherein the article is used for power loss recovery.

17. A system comprising:
a bit alterable memory comprising a plurality of cell colonies having at least one direction bit and at least two register bits;
a processor that communicates with the bit alterable memory through a transmission path; and
an antennae coupled to the transmission path.

18. The system of claim 17, wherein an interface determines the programming state of the plurality of cell colonies after a power loss using the direction bit and the register bits.

19. The system of claim 17, wherein a number of cells in each of the plurality of cell colonies is configurable.

20. A bit alterable memory comprising:
a plurality of cell colonies having at least one direction bit and at least two register bits; and
an interface to determine the programming state of the plurality of cell colonies after a power loss using the direction and the register bits.

21. The bit alterable memory of claim 20, wherein each of the plurality of cell colonies comprises a configurable number of cells.

22. The bit alterable memory of claim 20, wherein the interface determines whether, upon a read operation, the direction bit is at a first state or a second state wherein the plurality of cell colonies comprises at least a first memory cell colony and a second memory cell colony.

23. The bit alterable memory of claim 22, wherein if the interface determines that the direction bit is at the first state, designating that a first memory cell colony is valid.

24. The bit alterable memory of claim 22, wherein if the interface determines that the direction bit and one register bit is at the first state and at least one register bit is at the second state, designating that the programming operation is not complete.

25. The bit alterable memory of claim 22, wherein the interface determines that the direction bit is at the second state, designating that the second memory cell colony is valid.

26. The bit alterable memory of claim 22, wherein if the interface determines that the direction bit and one register bit are at the second state and at least one register bit is at the first state, designating that the programming operation is not complete.
